(19) United States
(12) Patent Application Publication
(10) Pub. No.: US 2012/0234261 A1
(43) Pub. Date: Sep. 20, 2012

(54) Looped Dog Walking Harness

(76) Inventor: Roger Nelson, Ponchatoula, LA (US)

(21) Appl. No.: 13/304,897

(22) Filed: Nov. 28, 2011

Related U.S. Application Data
(60) Provisional application No. 61/454,277, filed on Mar. 18, 2011.

(51) Int. Cl. A01K 27/00

(52) U.S. Cl. 119/792

(57) ABSTRACT

Disclosed is an improved harness for a quadruped animal, comprising a length of material forming a first and second closed loop, along with a connector means for forming the loops into a figure eight shape. The animal's forelegs are places through the first and second loops of the figure eight, while the intersecting connector is positioned centrally against the animal's chest. The outer ends of each loop are wrapped around the animal's shoulders and secured along the animal's back via a securing means such as a leash clasp. A leading strap can be attached to the harness for use when walking the animal, wherein the connector bears against the animal's chest and the position of the loops provides improved control over the actions of the animal. The harness prevents choking or twisting of the animal's neck, while allowing the user to have better over control.

### CROSS REFERENCE TO RELATED APPLICATION

This application claims the benefit of U.S. Provisional Application No. 61/454,277 filed on Mar. 18, 2011, entitled “Walking Collar.”

### BACKGROUND OF THE INVENTION

1. Field of the Invention

The present invention relates generally to a harness for an animal. More specifically, the present invention pertains to a harness for a quadruped animal, such as a dog, wherein chest and shoulder control is achieved without attaching a collar around the animal's neck.

A walking harness is a type of retaining device used for a quadruped animal, wherein the upper torso of the animal is secured to a tether for controlling movement and obedience of the dog. Restraining devices are used with particularly with dogs for movement control, identification and for novelty or fashion reasons. A leading strap is attachable to the retaining device and is used to keep the animal in close proximity to its owner when walking on a lead. The most common and traditional type of animal restraining device is a collar, which is a section of material placed around the animal's neck. Alternate restraints include shoulder and torso-mounted devices for controlling the core of the animal, rather than the neck region.

The problem encountered with traditional collars is the significant amount of pressure exerted on the animal's neck, which can choke or cause other injuries. When a dog pulls away from the user while walking on a lead, the resistance created is distributed to the trachea, which can cut off the animal's air supply and cause permanent damage. Knowledge regarding such injuries by animal owners has led to an increase in usage of shoulder and torso dog harnesses, particularly in small breeds of dogs. Harnesses have a loop surrounding the torso of the animal, which distributes the loads placed on a dog's neck to its chest, thereby preventing choking and muscle injury. A harness also prevents the animal from slipping out of its restraining device, which is a common problem associated with traditional around-the-neck collars.

While harnesses are designed to prevent problems traditionally associated with around-the-neck animal collars, they introduce additional issues. Traditional animal harnesses are well suited to prevent choking and neck injuries, however, many are extremely difficult to secure and remove from an animal. A standard harness requires the use of complicated securing means in order to properly restrain the animal, such as multiple fasteners and hooks. Such devices take a considerable amount of time and effort to install or remove, particularly in those animals that are not prone to remaining stationary for a user to apply the restraint.

The present invention improves upon harnesses used for quadruped animals with a design that removes the complicated securing means. The device comprises a length of material forming a first and second closed loop, and a means for connecting the loops to form a figure eight. In use, the animal's forelegs are placed through the first and second loops, with the intersection positioned at the animal's chest. Each outer end of the loop is wrapped around the animal's torso and is secured along its back by a closing means, such as a ring closure or leash clasp. A leash or leading strap can be attached to the harness for use when walking an animal. The device allows the user to control the animal via the closed loops, without choking or hurting the animal's neck. The continuous nature of the loops reduces clasp failure and further improves one's ability to secure the device onto the animal prior to walking.

2. Description of the Prior Art

Several devices have been disclosed in the art utilizing a figure eight configuration. Goldberg, U.S. Pat. No. 6,450,130 discloses a safety restraint for pets adapted for multiple uses, including utilization with an existing vehicular seat belt system. The restraint includes first and second closed loops formed by a length of webbing joined at its opposite ends and secured at a webbing intersection. Additionally, Goldberg, U.S. Pat. No. 5,794,571 discloses a safety restraint for pets, utilized with an existing vehicular seat belt system. The restraint includes a harness made of a single length of webbing attached at its ends to form an endless belt, the belt having first and second closed loops formed therein by intermediate securement of one side of the belt with the opposite side of the belt. A connecting strap and tether are connected to different parts of the loops to thereby releasably associate the loops and releasably associate the harness with the seat belt system. Strap sets are utilized to associate opposite sides of the loops to provide securement and fit adjustment on the pet at each loop.

While utilizing a figure eight configuration that better distributes pressure around an animal's torso, these harnesses have several known drawbacks. The prior art devices are primarily focused on protecting an animal during transport in a vehicle, and not designed to be easily and quickly secured or removed from an animal. A harness designed for use in a vehicle must absorb and distribute significantly higher forces than would normally be experienced by a dog that is walking on a lead. To accomplish this, the device must secure around a greater portion of the animal's body in order to distribute impact forces over a greater area. This can only be accomplished with a large number of straps, fasteners, and securing devices. While such a device is ideal for use in a vehicle, it makes securing and removing the harness a time consuming and difficult task.

The present invention improves upon animal harnesses by utilizing a design that is quickly and easily secured to the animal. The first and second loops lie across the chest of the animal in front of the forelegs, with the intersection positioned at the animal's chest. The outer end of each loop is wrapped around the animal's torso and is secured by a leash or similar clasp, allowing the device to be secured and removed as needed in a short amount of time. The design of the present invention substantially diverges in design elements from the prior art and consequently it is clear that there is a need in the art for an improvement to existing animal harnesses. In this regard the instant invention substantially fulfills these needs.

### SUMMARY OF THE INVENTION

In view of the foregoing disadvantages inherent in the known types of animal harnesses now present in the prior art, the present invention provides a new animal harness wherein the same can be utilized for providing convenience for the user when securing the device or removing it from an animal.

It is therefore an object of the present invention to provide a new and improved harness for a quadruped animal that has all of the advantages of the prior art and none of the disadvantages.

Another object of the present invention to provide a new and improved harness for a quadruped animal that secures around the chest and torso of an animal.

Another object of the present invention is to provide a new and improved harness for a quadruped animal that includes a first and second closed loop that are secured at an intersection and joined around an animal at opposite ends.

Another object of the present invention is to provide a new and improved harness for a quadruped animal that allows for attachment of a standard lead strap or leash.

Yet another object of the present invention is to provide a new and improved harness for a quadruped animal that is quickly and easily secured to and removed from an animal without the need for additional fasteners.

Another object of the present invention is to provide a new and improved harness for a quadruped animal that prevents choking and distributes pressure when and dog is walking on a lead.

A final object of the present invention is to provide a new and improved harness for a quadruped animal that is inexpensive and easy to manufacture.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention, including a first closed loop and second closed loop.

FIG. 2 shows a perspective view of the present invention in use and secured around a dog's chest.

FIG. 3 shows a perspective view of the present invention in use and secured around a dog's chest with a leading strap attached to the harness.

### DETAILED DESCRIPTION OF THE INVENTION

Reference is made herein to the attached drawings. Like reference numerals are used throughout the drawings to depict like or similar elements of the quadruped animal harness. For the purposes of presenting a brief and clear description of the present invention, the preferred embodiment will be discussed as used for securing around the chest of a dog. The figures are intended for representative purposes only and should not be considered to be limiting in any respect.

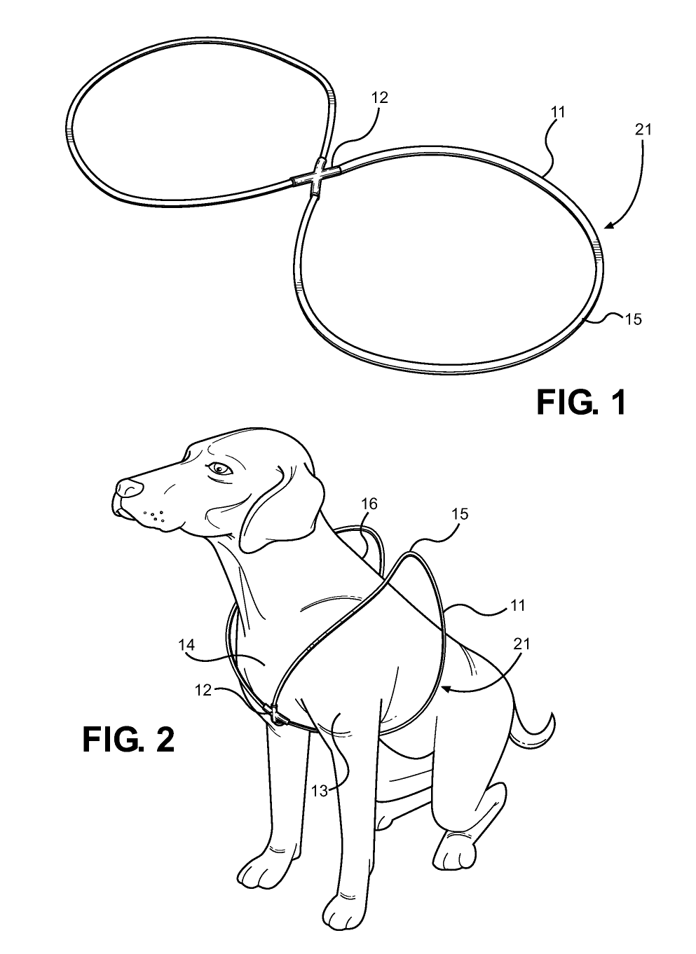

The preferred embodiment of the harness 21 of the present invention as shown in FIG. 1 is for use with a dog. The harness 21 comprises a length of continuous material forming a first and second closed loop 11. The length of material is joined at opposite ends, providing an outward appearance of a continuous, figure-eight shape. The harness 21 includes a connector 12 at the intersection of the first and second closed loops 11, which gives the harness 21 its figure eight shape and secure structure to withstand loads imparted by a leading dog. The connector 12 permanently maintains the first and second closed loops 11, which allows the harness 21 to be easily secured around the chest of an animal, as seen in FIG. 2. Additionally, the connector 12 includes a means for securing a pet identification tag thereto. This is particularly useful since many local ordinances require pets to carry an identification tag. Securing an identification tag at the loop intersection allows for placement at the upper chest of the animal, which affords optimal visibility should the pet escape from its owner.

The material forming the loops 11 may be made from a variety of materials that are appropriate for use in an animal harness, such as wrapped wire, webbing, leather, rope, nylon, rubber, or a combination thereof. As shown in the preferred embodiment, the material is flat nylon webbing. Flat webbing has been found to be a suitable material for the harness due to its flexibility and comfort when installed on the animal, while providing a material that does not elongate under load. The flat webbing has the ability to absorb tensile forces applied thereto, such as when a dog pulls when walking on a lead, without stretching. However, during installation, its inherent flexibility allows the user to easily place the harness onto the dog prior to use.

As shown in the preferred embodiment, the harness 21 is nonadjustable. This creates a simple device that does not require the use of buckles, fasteners, or straps to secure to an animal. The device is available in a variety of sizes, so that an animal owner can select an appropriate harness based on the size and breed of animal it is to be secured to. While contemplated as a nonadjustable harness 21, such an embodiment is not intended to limit the present invention. Alternatively, the present invention can include length adjuster buckles so that one harness 21 can accommodate a range of different sized dogs. This is accomplished with a securing means that allows for enlarging and reducing of the circumference of the loops 11, such as a buckle, fastener, or strap.

In use, as can be seen in FIG. 2, the harness 21 is placed on a dog and secured around its chest 14. The forelegs 13 are placed within the loops 11 so that the intersection 12 makes contact with the dog's chest 14. The outer portion 15 of the first and second closed loops 11 are wrapped around the animal's torso, thereby overlapping and coming to rest at the animal's withers 16.

As can be appreciated by those of skill in the art, the placement of the intersection 12 at the animal's chest 14 distributes the pressure caused by a dog walking on a lead more effectively than neck collars. Dogs have a tendency to pull when walking on a lead, which can cause the animal to choke. A traditional dog collar secures around the neck of the animal, allowing the animal to choke and potentially injure itself. With the present invention, the area of greatest pressure is moved from the neck to the chest. This prevents excess pressure from being placed on the trachea, which allows for a safer, more effective restraining device.

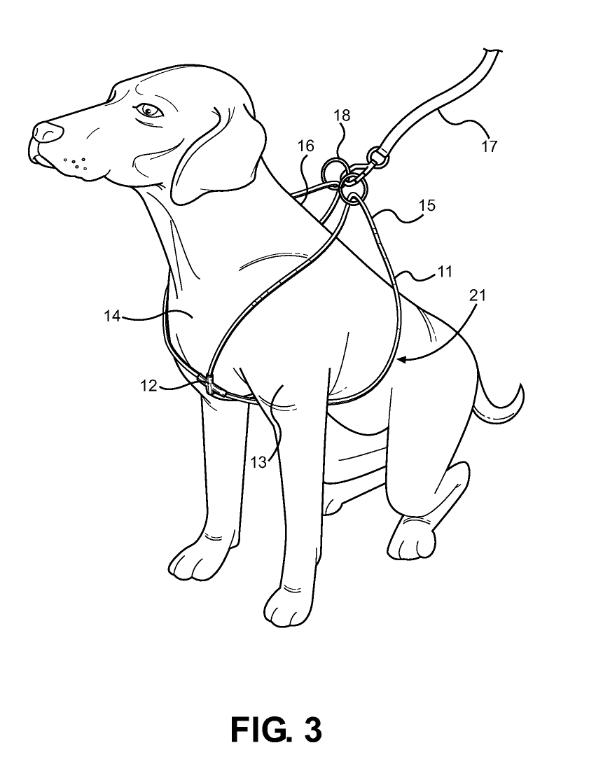

In use, as can be seen in FIG. 3, there is shown a perspective view of the present invention secured on a dog with a standard leading strap 17 attached thereto. The lead strap 17 clips onto the distal portion 15 of the loops 11 at the animal's withers 16. This can be accomplished with a pair of rings 18 that secure to the outer portion 15 of the loops 11. A user can clip the lead strap 17 to the rings 18, thereby creating a continuous loop that wraps around the dog's torso. In this way, the animal is prevented from slipping out of the harness 21. In an alternate embodiment, a leash 17 can be clipped directly to the loops 11, which would not require the use of a pair of rings 18.

When a dog wearing the harness 21 is being walked, the rings 18 will lie at the midline of the dog between the withers 16, and the connector 12 will lie at the dog's chest 14. The connection at the rings 18 helps to maintain the harness 21 in the correct position across the chest of the animal. The lead strap 17 can be held to either the left or right side of the dog. If the dog pulls against the lead, it is easily restrained, with the exerted force being transferred to the animal's chest. If a dog wearing the harness 21 is reluctant to walk forward, the owner can encouraged it to do so by pulling on the lead strap 17.

The present invention provides a user with a convenient and inexpensive harness for a quadruped animal, such as a dog. The device is quickly and easily secured to and removed from an animal when compared to a standard harness that requires the use of complicated securing means in order to properly restrain the animal, such as multiple fasteners and hooks. The nonadjustable nature of the device makes it inexpensive and simple to manufacture. The placement of the strap on the chest of the animal, instead of the neck, affords an added level of safety to a dog that may pull when walking on a lead. In alternate configurations, the connector 12 may be positioned on the dog's back, while the leash is placed on the chest of the dog. This configuration reverses the preferred configuration, and provides the user with an alternate means to guide the dog and reduce dog pulling. The leash connects is awkwardly positioned such that pulling will turn the dog off course or be uncomfortable, reducing the pulling tendency during walks. Still further, the present invention may be used on an animal's hind legs as a means for supporting the dog after an operation or procedure wherein hind leg mobility or strength is reduced. The hind legs are placed into the first and second loops, as opposed to the forelegs, and the rear of the dog may be vertically supported by a user. These alternate configurations are variations on the use of the same device, which is provided as a continuous, figure-eight harness that is simple to deploy and manufacture.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A harness for a quadruped animal, comprising:
a length of continuous material forming a first and second closed loop and joined at opposite ends by a connector to form a figure-eight;
said closed loop adapted to accommodate the legs of an animal and said closed loop outer ends adapted to extend around the torso of said animal;
a securing means for joining said closed loop outer ends together and to a lead strap.

2) A device as in claim 1, wherein said securing means for securing a lead strap to said harness is a pair of rings.

3) A device as in claim 1, wherein said intersection contains a means for securing an identification tag.

4) A device as in claim 1, wherein said first and second closed loops are nonadjustable.

5) A device as in claim 1, wherein said first and second closed loops further comprise a length adjuster buckle for increasing and reducing the circumference of said loop.
